(19) United States
(12) Patent Application Publication
(10) Pub. No.: US 2019/0080375 A1
(43) Pub. Date: Mar. 14, 2019

(54) SYSTEMS AND METHODS FOR VIRTUAL GIFTING IN AN ONLINE CHAT SYSTEM

(71) Applicant: Andy V. Alvarez, Tampa, FL (US)

(72) Inventor: Andy V. Alvarez, Tampa, FL (US)

(21) Appl. No.: 15/943,643

(22) Filed: Apr. 2, 2018

Related U.S. Application Data
(63) Continuation of application No. 15/703,776, filed on Sep. 13, 2017.

(51) Int. Cl. G06Q 30/06; G06Q 20/26; H04L 12/58

(52) U.S. Cl. CPC G06Q 30/0601; G06Q 20/26; H04L 51/32; H04N 7/147; H04L 51/10

(57) ABSTRACT

A chat service and/or social networking service that enables users of the system to conduct live chats with one another, and provides the ability of a user to give a virtual gift to another user with whom they are conducting a chat. The virtual gifts may have monetary value, or any other tangible or intangible thing of value.

### CROSS-REFERENCE TO RELATED APPLICATION

The present application is a continuation of prior non-provisional patent application, Ser. No. 15/703,776 entitled SYSTEMS AND METHODS FOR VIRTUAL GIFTING IN AN ONLINE CHAT SYSTEM, filed Sep. 13, 2017, which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to online chat systems and more specifically to online chat systems that provide users the ability to give virtual gifts to one another.

### BACKGROUND

Online chat systems provide a way for users to interact with each other or business purposes or for entertainment purposes. There are some persons who make their living as entertainers on phone lines and chat systems. Hence such persons need to be paid for their time. In such a chat system, one way for entertainers to be paid for their time is through virtual gifts, essentially a tip that is presented in the form of a gift such as ring or flowers or candy. Such a system could also allow friends to give each other a virtual gift now and then just as a gesture of affection, or it could allow family members to give each other virtual gifts, for example, as birthday presents. Such virtual gifts could have an underlying cash value, or could represent anything else of value.

### BRIEF DESCRIPTION OF THE DRAWINGS

The embodiments are illustrated by way of example and not limitation in the figures of the accompanying drawings in which like references indicate similar elements.

FIG. 1 shows an exemplary unit user interface for a mobile App in accordance with present disclosure.

FIG. 2 illustrates how a chat system in accordance with the present disclosure is capable of linking a single user to a group of users simultaneously.

FIG. 3 shows a high-level view of an embodiment of a chat system in accordance with the present disclosure.

FIG. 4 shows a conceptual of the subsystems comprising one embodiment of a chat service server in accordance with the present disclosure

FIG. 5 illustrates one embodiment of a process by which a user can purchase virtual gifts that can then be given to other users.

FIG. 6 illustrates one embodiment of a process by which a first user can give a virtual gift to a second user.

FIG. 7 illustrates one embodiment of a process by which a user can give another user a bonus.

### DETAILED DESCRIPTION

In an embodiment, the present disclosure relates to a method. A purchase transaction for a virtual gift item is received from a first user device by at least one computing device, via a communications network. The purchase transaction is processed by the computing device, whereby the virtual gift item is associated with the first user on a data-base accessible to the computing device. A real-time chat session is provided, by the computing device, via the communications network, between the first user device of the first user and a second user device of a second user, whereby the first user and the second user are enabled to engage in real-time chat during the real-time chat session. A gift transaction to give the virtual gift to the second user is received by the computing device, via the communications network, from the first user device during the real-time chat session. The gift transaction is processed by the computing device, whereby the virtual gift is associated with the second user on the database and is disassociated from the first user on the data-base.

In another embodiment, the present disclosure relates to a method. A database, accessible to at least one computing device, is provided, wherein a plurality of first users are each associated with at least one respective virtual gift item on the database. A respective real-time chat session between a respective user device of each of the plurality of first users and a second user device of a second user is provided by the computing device, via the communications network, whereby each of the plurality of first users and the second user are enabled to engage in real-time chat during the respective real-time chat session. A respective gift transaction to give a respective virtual gift item to the second user is received by the at least one computing device, via the communications network, from each of the respective user devices of the plurality of first users. Each of the respective gift transactions is processed by the at least one computing device, whereby each of the virtual gift items is associated with the second user on the database and disassociated from the respective first user on the database.

In another embodiment, the present disclosure relates to a method. A virtual gift item is associated with a first user of a social networking system. A real-time chat session between the first user and a second user of the social networking system is provided via the social networking system. A gift transaction to give the virtual gift to the second user is received by the social networking system from the first user during the real-time chat session. The gift transaction is processed by the social networking system, whereby the virtual gift item is associated with the second user on the social networking system and disassociated from the first user on the social networking system.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, the term “server” or “computing device” should be understood to refer to a service point which provides processing, database, and/or communication facilities. By way of example, and not limitation, the term “server” or “computing device” can refer to a single, physical processor with associated communications and data storage and/or database facilities, or it can refer to a networked or clustered complex of processors and associated network and storage devices, as well as operating software and one or more database systems and applications software which support the services provided by the server. In various embodiments, servers and/or computing devices may be provided as virtual servers and computing devices, which may be cloud-based. In various embodiments, databases may be hosted on cloud-based data storage. In various embodiments, servers or computing devices may be capable of receiving, capturing, and transmitting audio and/or video data.

For the purposes of this disclosure, the term “mobile device” should be understood to refer to any kind of computing device that is designed to be easily carried by a user to any location of the user's choosing. Examples of a mobile device include a smart phone, a cell phone, a tablet computer, and a laptop computer. Mobile devices commonly include wireless communications capabilities such as, for example, cellular communications capabilities, or Wi-Fi, and may be additionally capable of being connected to a hardwired network, such as an Ethernet network. Mobile devices may additionally include cameras, and microphones, that enable users to capture and transmit audio and visual data via available networks.

For the purposes of this disclosure a subsystem, is a software, hardware, or firmware (or combinations thereof) system, process or functionality, or component thereof, that performs or facilitates the processes, features, and/or functions described herein (with or without human interaction or augmentation). A subsystem can include sub-subsystems. Software components of a subsystem may be stored on a computer-readable medium. Subsystems may be integral to one or more servers, or be loaded and executed by one or more servers.

For the purposes of this disclosure, the term “chat service” should be understood to refer to a service accessible via a network, for example, the Internet or a cellular network, that enables users to conduct live, real-time or near time conversations with one another in text form, audio form, and or audiovisual form using their respective user devices.

For the purposes of this disclosure, the term “social network” should be understood to refer to a system accessible via a network, for example, the Internet, where a community of users can establish accounts, post and share content, and interact with one another through various means, such as publicly viewable posts or private messages to one another. Examples of social networks are Facebook®, Google+®, LinkedIn®, and Twitter®.

For the purposes of this disclosure a computer-readable medium stores computer data, which data can include computer program code that is executable by a computer, in machine readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory, or other solid state memory technology, CDROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

The present disclosure is directed to systems and methods to provide a chat service and/or social networking service that enables users of the system to conduct live chats with one another, and provides the ability of a user to give a virtual gift to another user with whom they are conducting a chat.

For the purposes of this disclosure, the term “virtual gift” should be understood to refer to an item represented in digital format that can be transferred from one user of a chat service or social network to another user via the chat service or social network. Such items could correspond to anything tangible or intangible that has value, for example, without limitation, a monetary amount, a gesture of affection, bonus points, or physical gift items.

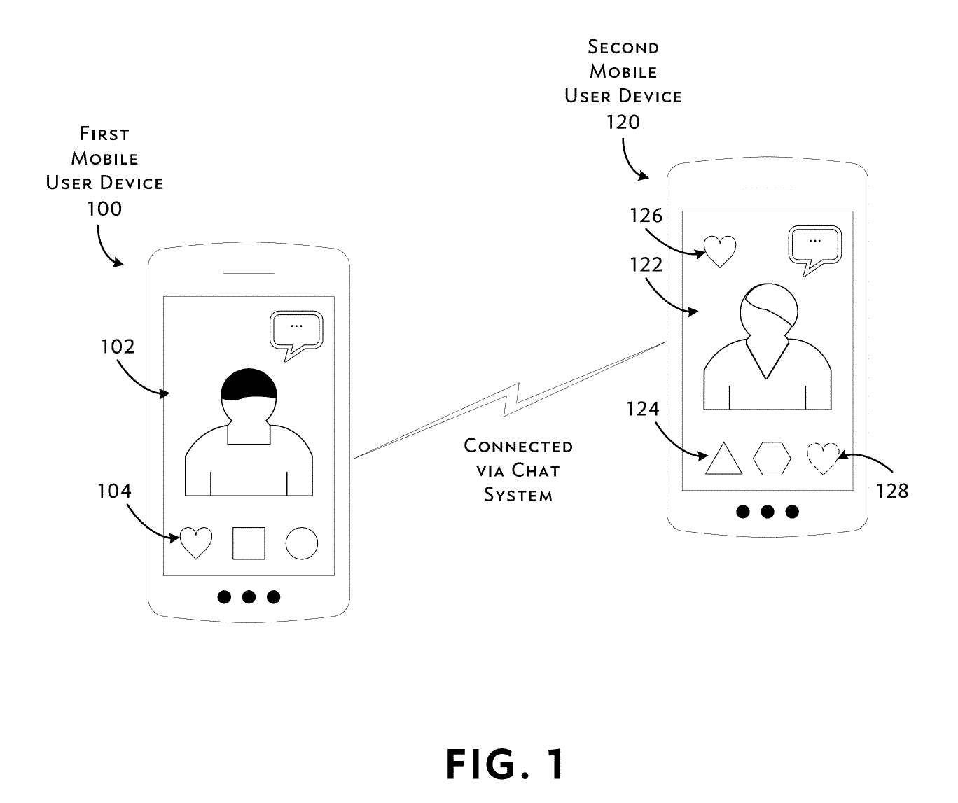

FIG. 1 illustrates an exemplary chat on a chat system supporting virtual gifting. A first user, via the user's device 100, has established a real-time chat session via a chat system with a second user, via the second user's device 120. It is understood that the graphical user interface displayed in FIG. 1 is purely exemplary, and many other user interface configurations could provide similar functionality.

In the illustrated embodiment, the user interface hosted on the first user mobile device 100 displays a live video 102 of the second user, where such live video is obtained from a camera associated with the second user mobile device via the chat system. In various embodiments, a live audio feed of the second user is also provided to accompany the live video 102.

Correspondingly, in the illustrated embodiment, the user interface hosted on the second user mobile device 200 displays a live video 122 of the first user, where such live video is obtained from a camera associated with the first user mobile device via the chat system. In various embodiments, a live audio feed of the first user is also provided to accompany the live video 102.

In the illustrated embodiment, the first user wishes to give a virtual gift to the second user during a chat session. The user interface 102 displayed by the first user's mobile device displays a gift area 104 at the bottom interface 102. In the illustrated embodiment, there are three icons representing three virtual gifts associated with the first user displayed in a gift area 104 on the first user's mobile device. In various embodiments, the first user has previously purchased the virtual gifts represented in the gift area 104, or previously received them from another user. In other embodiments, the virtual gifts represented in the gift area 104 could represent virtual gifts that are automatically purchased on behalf of the first user when first user gives such virtual gift to another user.

The first user initiates a gift transaction to give one of the virtual gifts, for example the gift represented by a heart icon, to the second user by taking a user interface action on the user interface 102. In an embodiment, such user interface action could comprise tapping on the heart icon. In an embodiment, such user interface action could comprise swiping the heart icon onto the face of the second user displayed on the user interface 102. Various other user interface actions could be designed which might or might not involve interacting directly with the display of the first user's mobile device 100, as will be readily understood by those skilled in the art. For example, by sound, shaking the device, by scanning a code, or by a voice command.

In the illustrated embodiment, the chat system (not shown) processes the gift transaction and transfers the virtual gift to the second user. In various embodiments, the second user is notified of the gift via the user interface 122 on the user's device 120. In the illustrated embodiment, the gift the second user has received is displayed in the top left-hand corner 126 of the user interface 122. The gift may then also be displayed in the second user's gift area 128. The second user, in various embodiments, can redeem the virtual gift for its value, for example, a monetary amount, or retain the gift and give it to another user.

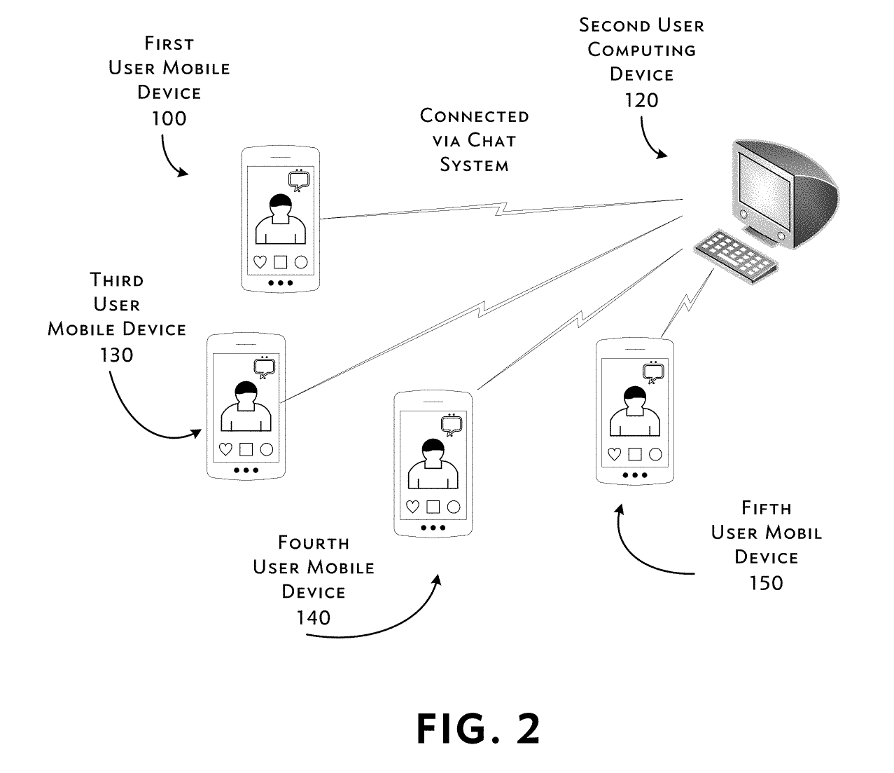

Referring now to FIG. 2, in the illustrated embodiment, the chat system (not shown) can allow a the second user to engage in a plurality of simultaneous real-time chat sessions, via the second user's computing device 120, with a plurality of other users via such user's mobile devices 100, 130, 140, and 150. In an embodiment, all of the users shown in FIG. 2 can give virtual gifts to one another. In an embodiment, only a specific class of users and give gifts and receive gifts. For example, in FIG. 2, the first user, the third user the fourth user, and the fifth user are only able to give gift, but not receive them. Whereas the second user may only be able to receive gifts but not give gifts. The second user's computing device 120 could be a mobile device, or could be a device better suited to maintaining multiple conversations at the same time, for example a desktop computer or laptop.

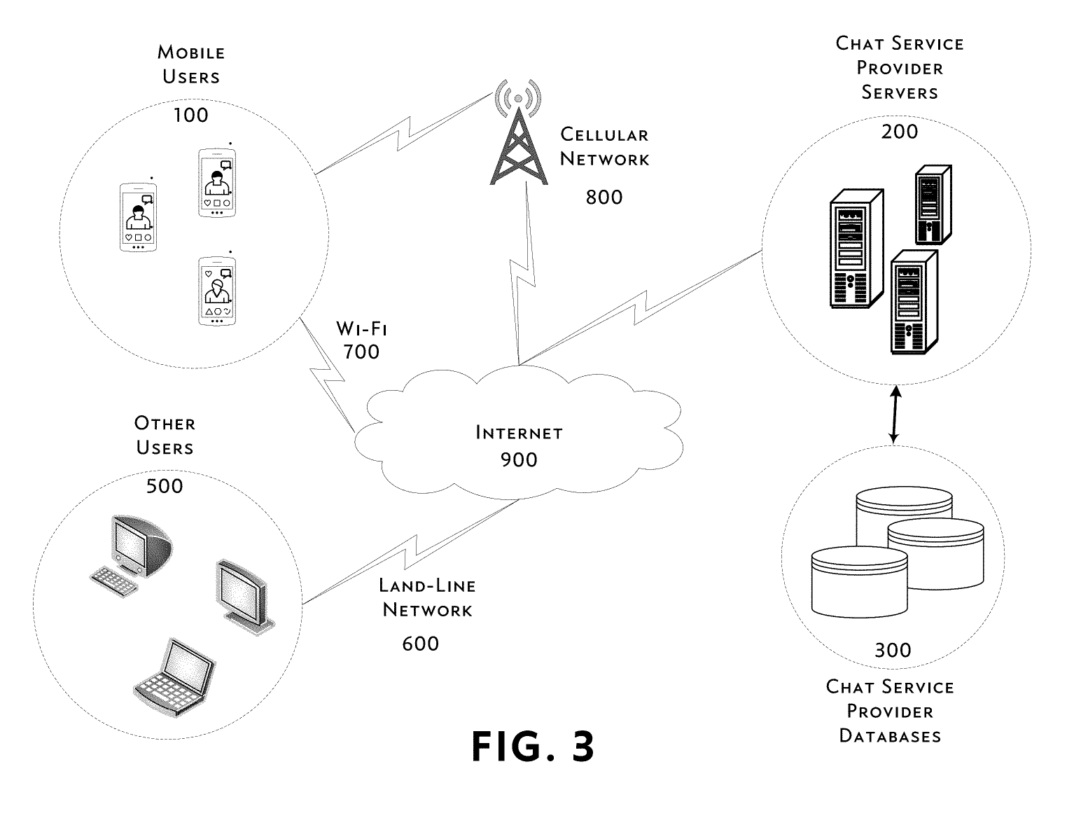

Referring now to FIG. 3, an exemplary system in accordance with present disclosure is presented. The system is implemented using an App that allows mobile users 100 and other users 500 (e.g. desktop users) to communicate with a chat service provider server 200, establish audiovisual or text-based chat sessions with other users, and additionally provides the ability for users to give virtual gifts to one another. Mobile users 100 and other users 500 can connect to the chat service provider servers via the Internet 900 which the users can reach using any available connection for example a landline network 600, a Wi-Fi network 700, or a cellular network 800.

In an embodiment, the App enables users to register an account with the chat, with a user name, optionally a photo or avatar, and a phone number. In an embodiment the App requests permission to make/receive calls, make/receive SMS messages, and use a camera associated with the user devices 100 and 500. The chat service provider servers 200 enables users 100 and 500 to effectively set up a two way video conference between each other, where the chat service provider servers manages the video conference.

In an embodiment, the App enables users 100 and 500 to buy virtual gifts using a credit/debit card. In an embodiment, users 100 and 500 are required to purchase virtual coins using credit/debit cards first, then use the virtual coins to buy virtual gifts. In an embodiment, one user 100 or 500 can give virtual gift other users during a chat session. In an embodiment, virtual gifts can be redeemed for cash. In an embodiment, the chat service provider servers collect revenue for the system owner by either charging a percentage or flat fee when gifts are purchased or received.

In an embodiment, all users 100 or 500 can assume the role of a broadcaster, live streaming some kind of interactive session or event to many other viewing users. In an embodiment, all users can apply the role for broadcaster 100 or 500, but will be evaluated before their application is approved. In an embodiment, broadcasting users are provided with a different user interface that permits the broadcasting user to interact multiple users at the same time more easily. For example, a desktop application for users with desktop computers 500 could be provided that allows such users to display multiple chat windows on the same device.

In an embodiment, where broadcasting users pay a fee to the chat service provider, is it a percent value of virtual gifts received, and/or a flat amount per gift. In an embodiment, compensation to broadcasting users tiered with volume, for example, the broadcasting user pays lower fees as the volume gifts broadcasting user receives increases. In an embodiment the system enables a browser-based interface. In an embodiment, the system implements age controls. In an embodiment, the system monitors and controls abuse and bullying. In an embodiment, the system monitors for other illegal activities in an embodiment, the system additionally provides a complaint/report system.

In an embodiment, all persistent data associated with the chat service is stored on chat service provider databases 300. For example, user account information could be stored on the chat service provider database, as well as data relating to virtual gifts purchased by user. In various embodiments the databases 300 could be implemented using any suitable database, for example Redis, memcache. Mysql, or MongoDB. Such databases could be at the same location the servers 200 are located. Alternatively or in addition, such databases could be remote to the servers 200, and could be cloud-based.

In an embodiment, the chat service provided by the chat service provider servers 200, and the chat service provider databases 300, is a social networking service that additionally implements the functionality described above and below.

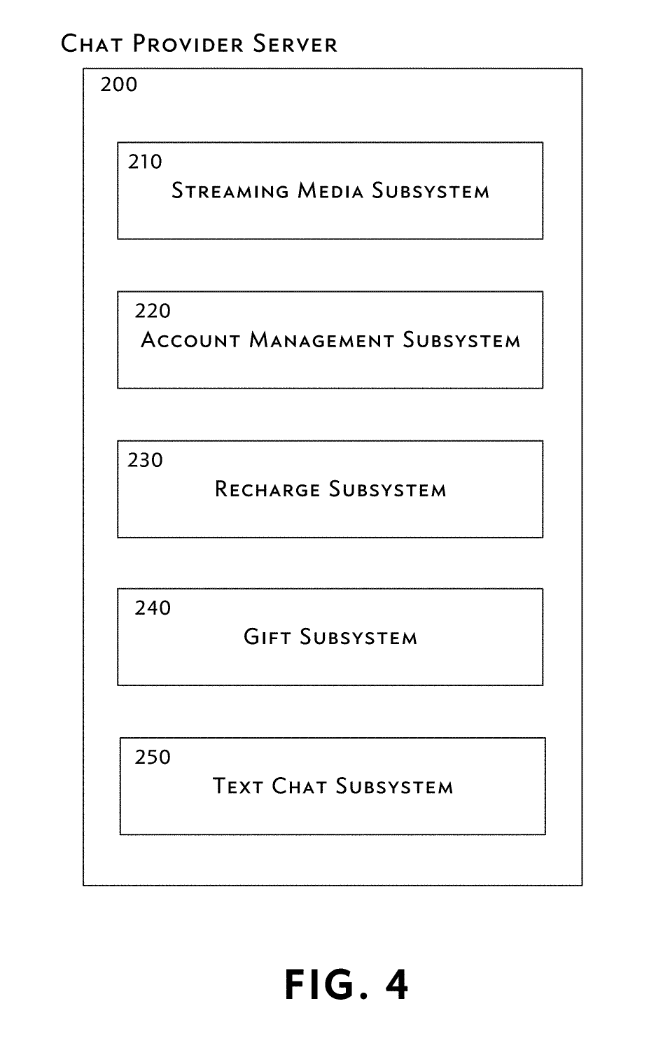

Referring now to FIG. 4, an exemplary embodiment of major subsystems implemented on a chat service provider server 200. It is to be understood that these subsystems represent only one embodiment of subsystems on a chat service provider server 200, and that other embodiments could include additional subsystems or omit one or more subsystems shown in FIG. 4.

Is to be further understood that these subsystems could be implemented by software, specialized hardware, or a combination thereof. In an embodiment the subsystems are implemented using a combination of C++, Java, Go, and Python.

The server 200 provides a streaming media subsystem 210 that manages the video portions of chat sessions. The server 200 additionally provides an account management subsystem 220 that manages user accounts on the system. The server 200 additionally provides a recharge subsystem 230 that charges users for use of the chat system, and in an embodiment, enable the purchase of virtual coins as described above. The server 200 additionally provides a gift subsystem 240 that tracks virtual gifts purchased or received by users, and provides for the redemption of virtual gifts for cash or credit. The server 200 additionally provides a text chat subsystem 250 that supports text chat between users.

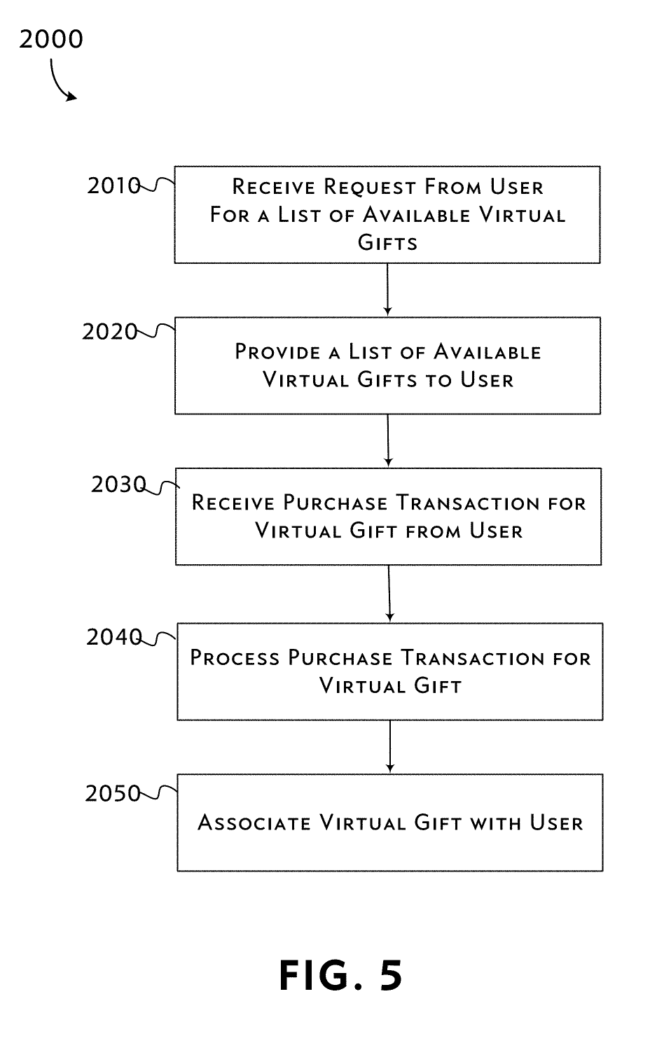

FIG. 5 illustrates an embodiment of a computer-implemented process 2000 by which a user can purchase virtual gifts on a chat system. Unless otherwise specified, it should be understood that the processing described with respect to each of the blocks of FIG. 5 is performed by at least one computing device maintained or controlled by a chat service provider service. In an embodiment, such a computing device could be one or more of the chat service provider servers 200 of FIG. 3 and FIG. 4.

In block 2010 of the process, a request is received from a user for a list of available virtual gifts. It is understood that the user is logged in to the chat service. In an embodiment, user has previously registered with the chat service and has an established account. In an embodiment, a user might login under a new account or anonymously. In an embodiment, the user is required to provide a credit card to pay for chat services used by the user, to pay for virtual coins, and/or to pay for virtual gifts. Various other embodiments, the user is required to provide some kind of identifying information, such as a user selected username, and email address, and a phone number.

In block 2020 of the process, a list of available virtual gifts is provided to the user. Such virtual gifts could take any form, for example a virtual diamond ring, a virtual rose, virtual candy box, or virtual car. In various embodiments, each virtual gift represents a cash value established for the virtual gift, the form of the virtual gift itself being fanciful, but implying a general sense of the value of the virtual gift. In other embodiments, the virtual gift represents some other thing of tangible or intangible value such as, for example, a tangible gift, virtual coins, a gesture of affection, or status within the chat system

In block 2030 of the process, a purchase transaction for a virtual gift is received from the user. In block 2040 of the process, purchase transaction for a virtual gift is processed. In an embodiment, the user is charged for the cost of the virtual gift, for example, through a charge to a stored debit or credit card associated with the user's account. In an embodiment, the user is charged for the cost of the virtual gift in virtual coins which the user previously purchased using a stored debit or credit card. In block 2050 of the process, the virtual gift is associated with the user's account. The user is then able to give the virtual gift to another user who is engaged in a chat with the user.

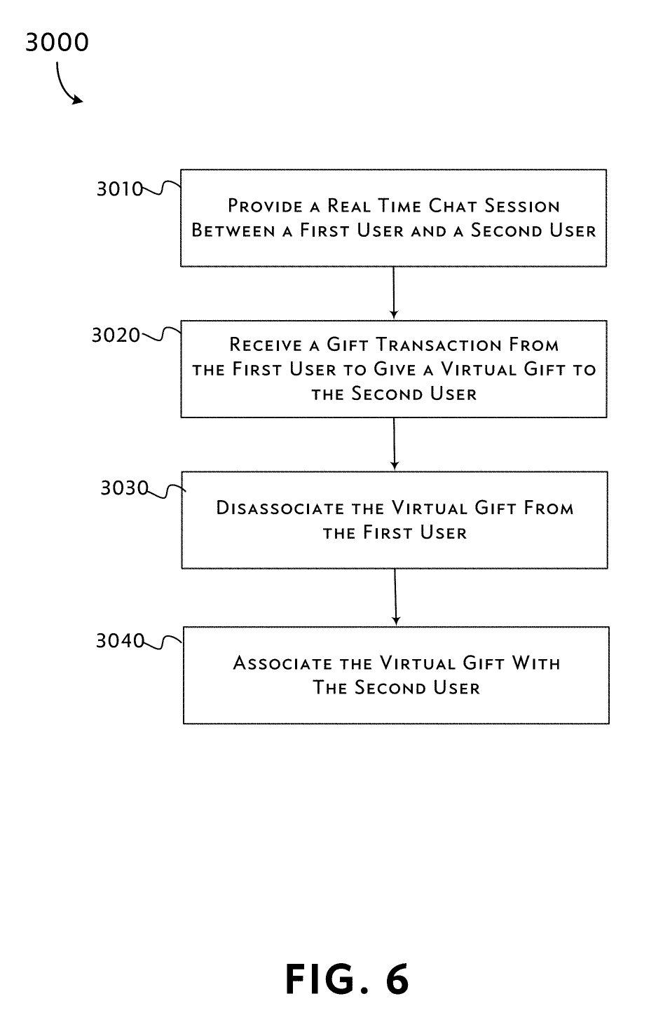

FIG. 6 illustrates an embodiment of a computer-implemented process 3000 by which a user can give virtual gifts to other users on a chat system. Unless otherwise specified, it should be understood that the processing described with respect to each of the blocks of FIG. 6 is performed by at least one computing device maintained or controlled by a chat service provider service. In an embodiment, such a computing device could be one or more of the chat service provider servers 200 of FIG. 3 and FIG. 4.

In block 3010 of the process, a real-time chat session is established between a first user and a second user who have logged onto a chat service in accordance with the present disclosure. The real-time chat session could be audio and visual, could be a text-based chat session, or a combination thereof.

In block 3020 of the process, a gift transaction is received from the first user to give a virtual gift to a second user. In an embodiment, the virtual gift was previously purchased by the first user. In an embodiment, the virtual gift is purchased during the chat session. In various embodiments, the user interface provided by the mobile or desktop App displays virtual gifts owned by the first user during the chat session. The App can provide a variety of mechanisms for the first user to give virtual gift to a second user, for example, without limitation, tapping on an icon representing a virtual gift, swiping an icon representing virtual gift, using a text command, or using a voice command, or any other manner of user interface interaction now known or later to be developed in the art.

In block 3030 of the process, the virtual gift is then dissociated from the first user and associated in block 3040 of the process with the second user. The second user can then either redeem the gift for credit, cash, virtual coins, or any other thing of tangible or intangible value. Alternatively, the second user could choose to give the gift to another user in another chat session.

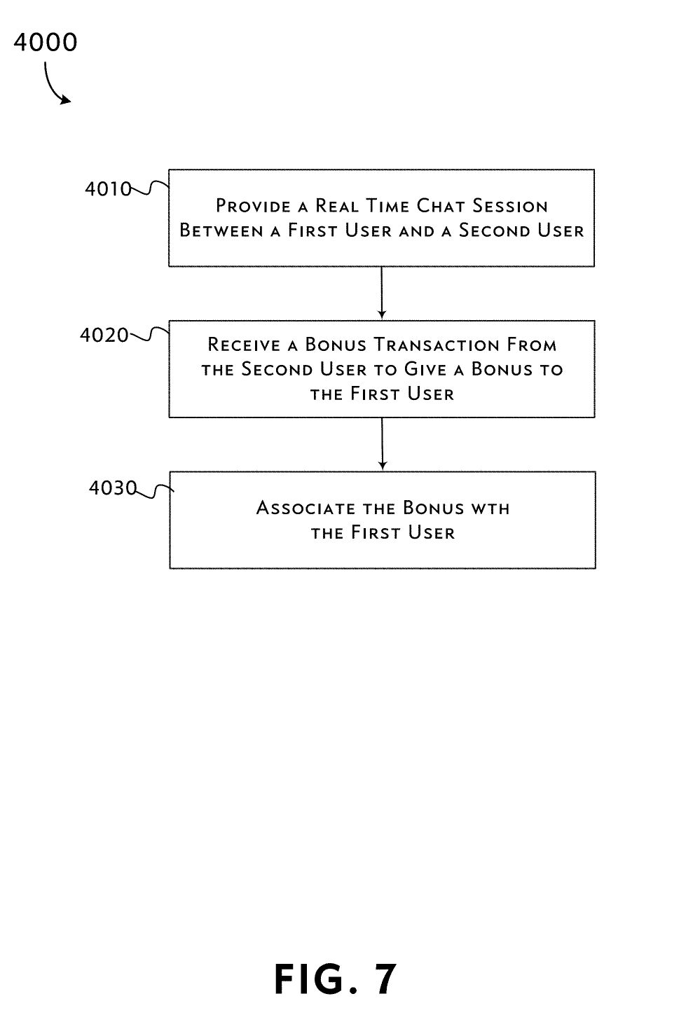

FIG. 7 illustrates an embodiment of a computer-implemented process 4000 by which a user can give bonuses to other users on a chat system. Unless otherwise specified, it should be understood that the processing described with respect to each of the blocks of FIG. 7 is performed by at least one computing device maintained or controlled by a chat service provider service. In an embodiment, such a computing device could be one or more of the chat service provider servers 200 of FIG. 3 and FIG. 4.

In block 4010 of the process, a real-time chat session is established between a first user and a second user who have logged onto a chat service in accordance with the present disclosure. The real-time chat session could be audio and visual, could be a text-based chat session, or a combination thereof.

In block 4020 of the process, a bonus transaction is received from the second user to award a bonus to the first user. Such bonuses could take any form having symbolic or monetary value. The bonus could be simply an expression of affection. Such bonuses could also, for example, increase the ranking of a given user on the system. Such bonuses could also, for example, take the form of virtual coins or virtual gifts. Such bonuses, could also for example, take the form of a rating of the first user by the second user.

In block 4030 of the process, the bonuses then associated with the first user. Thus, an exemplary interaction between a first user and a second user who are engaged in a real-time chat session, the first user could give a virtual gift to the second user as shown in FIG. 6, the second user could in return give the first user a bonus which could be simply an expression of affection, could increase the first users ranking on the chat service, or any other bonus having some symbolic or monetary value.

It will be readily appreciated by those skilled in the art, that users could also automatically receive bonuses for system activity, for example the user could be increased in ranking on the chat service based on the total value of gifts given to various other users, or could receive a bonus virtual coins based on the total value of gifts given to various other users, or could receive a bonus based on positive rankings of other users.

It will also be readily appreciated by those skilled in the art, that the chat service described above to be used for other purposes beyond simply social interaction or entertainment. For example, the service could be readily adapted for crowdfunding activities. Other extensions could also be added, for example simulated talk via rule-based artificial intelligence.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A method comprising:
receiving, by at least one computing device, via a communications network, from a first user device of a first user, a purchase transaction for a virtual gift item;
processing, by the at least one computing device, the purchase transaction, whereby the virtual gift item is associated with the first user on a database accessible to the at least one computing device;
providing, by the at least one computing device, via the communications network, a real-time chat session between the first user device of the first user and a second user device of a second user, whereby the first user and the second user are enabled to engage in real-time chat during the real-time chat session;
receiving, by the at least one computing device, via the communications network, from the first user device, during the real-time chat session, a gift transaction to give the virtual gift item to the second user; and
processing, by the at least one computing device, the gift transaction, whereby the virtual gift item is associated with the second user on the database and disassociated from the first user on the database.

2. The method of claim 1 wherein the virtual gift has a monetary value.

3. The method of claim 1 wherein the virtual gift represents a tangible item.

4. The method of claim 1 wherein the virtual gift represents an expression of affection.

5. The method of claim 1 wherein the first user device and the second user device are capable of transmitting audio and visual data and the real-time chat session is an audiovisual chat session between the first user and the second user.

6. The method of claim 1 wherein the first user device and the second user device are capable of transmitting audio and visual data and the real-time chat session is a text-based chat session between the first user and the second user.

7. The method of claim 1 wherein a cost is associated with the virtual gift item and the processing the purchase transaction additionally comprises charging the cost associated with the virtual gift item to an account of the first user.

8. The method of claim 7 wherein the cost is associated with the virtual gift item is charged to the account of the first user by charging a debit or credit card associated with the first user.

9. The method of claim 7 wherein the cost is associated with the virtual gift item is charged to the account of the first user by charging the first user in virtual coins.

10. The method of claim 1 additionally comprising:
increasing, by the at least one computing device, a ranking of the first user on a chat system based on a value of the virtual gift.

11. The method of claim 1 additionally comprising:
receiving, by the at least one computing device, via the communications network, from the second user device, a bonus transaction to award a bonus to the first user;
processing, by the at least one computing device, the bonus transaction whereby a bonus is associated with the first user on the database.

12. The method of claim 11 wherein the bonus transaction increases a ranking of the first user on a chat system.

13. The method of claim 11 wherein the bonus transaction is an expression of affection.

14. The method of claim 11 wherein the bonus transaction is awards a virtual gift or virtual coins to the first user.

15. The method of claim 11 wherein the bonus transaction is a rating of the first user by the second user.

16. A method comprising:
providing a database, accessible to at least one computing device, wherein a plurality of first users are each associated with at least one respective virtual gift item on the database;
providing, by the at least one computing device, via the communications network, a respective real-time chat session between a respective user device of each of the plurality of first users and a second user device of a second user, whereby each of the plurality of first users and the second user are enabled to engage in real-time chat during the respective real-time chat session;
receiving, by the at least one computing device, via the communications network, from each of the respective user devices of the plurality of first users, a respective gift transaction to give the at least one respective virtual gift item to the second user; and
processing, by the at least one computing device, each of the respective gift transactions, whereby each of the virtual gift items is associated with the second user on the database and disassociated from the respective first user on the database.

17. A method comprising:
associating, on a social networking system, a virtual gift item with a first user of the social networking system;
providing, via the social networking system, a real-time chat session between the first user and a second user of the social networking system;
receiving, by the social networking system, from the first user, during the real-time chat session, a gift transaction to give the virtual gift to the second user; and
processing, by the social networking system, the gift transaction, whereby the virtual gift item is associated with the second user on the social networking system and disassociated from the first user on the social networking system.

18. The method of claim 17 wherein the real-time chat session is an audiovisual chat session between the first user and the second user.

19. The method of claim 17 additionally comprising:
receiving, on the social networking system, from the second user device, a bonus transaction to award a bonus to the first user;
processing, by the social networking system, the bonus transaction whereby a bonus is associated with the first user on the social networking system.

20. The method of claim 19 wherein the bonus transaction increases a ranking of the first user on the social networking system.
